(19) United States
(12) Patent Application Publication
(10) Pub. No.: US 2009/0125934 A1
(43) Pub. Date: May 14, 2009

(54) USER RATING MECHANISM FOR MEDIA CONTENT

(75) Inventors: David Jones, Seattle, WA (US); Thamer Abanami, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/938,286

(22) Filed: Nov. 11, 2007

(51) Int. Cl. H04N 7/16

(52) U.S. Cl. 725/28

(57) ABSTRACT

An intuitive, user-friendly user ratings mechanism for using user ratings to affect operations of content management devices, such as PCs, and content playback devices, such as portable media players, is discussed. The user ratings mechanism can be employed on PC clients, consumer electronics, mobile devices, other entertainment appliances, or in a network environment. The user ratings associated with various digital content items generally reflect a user opinion in a binary emotional context that is virtually universally understood (for example, “I Like It” or “I Don't Like It”). In one scenario, a user can choose between two options to rate a content item, or can choose to leave the content item unrated.

### BACKGROUND

As consumer amass digital content and the cost of electronic storage continues to decline, digital content is increasingly hosted and consumed on a variety of devices, including but not limited to: servers, personal computers, hand-held computers, portable phones, personal digital assistants, in-vehicle devices, and home entertainment devices.

Current techniques for discovery, management, and playback of large collections of content items can be cumbersome for consumers. There is a growing need for platforms and techniques that effectively allow people to efficiently and intuitively discover, manage, and play content that is stored in various devices.

### SUMMARY

A system and method including a user ratings mechanism (“URM”) are described that can automatically improve the discovery, playback, and management experience from online services or stored resources. The URM is highly intuitive and user-friendly. Systems and methods implementing or using the URM can be employed on both network-side devices and client-side devices such as PCs, home-based consumer electronics, mobile devices, or other entertainment appliances, and are adaptable for use with, and use, legacy ratings techniques.

Generally, the ratings mechanism is based on a user choice, which may advantageously be a binary choice (as well as the option to not provide a ratings score) that reflects a universally understood personal emotional context. For example, the ratings choices may be “I like it” (“ILI”) (e.g., thumbs-up or a heart icon), “I don't like it” (“IDLI”) (e.g., thumbs down or a broken heart icon), or unrated (“UR”). Stronger personal emotional contexts are also possible, such as “I love it”, or “I hate it.” In the context of a particular content item, once the choice has been made by a consumer on a given device, the choice is associated with the content item (by tagging the content item with metadata reflecting the choice, for example). The association serves to identify the consumer's personal opinion of the digital content in an emotional context that is virtually universally understandable. The user's ratings choice may be reflected on any related devices to which the first device is occasionally or periodically synchronized. If the choice is made by a consumer on an online service and stored, e.g., on an online profile or via use of a cookie, then the choice may be manifested (even as part of the media file) on consumer systems and devices if that content item is downloaded onto a user device.

A variety of options using the ratings are then available to the user. These options may pertain to any or all of the phases of content discovery, content management, and content playback.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 illustrates a simplified functional block diagram of an exemplary communication environment in which embodiments of the user ratings mechanism described herein may be implemented or used.

FIG. 2 is a simplified functional block diagram of the user ratings mechanism shown in FIG. 1.

FIG. 3 is a flowchart illustrating certain aspects of a method performed by aspects of the communication environment shown in FIG. 1 and/or the user ratings mechanism shown in FIG. 2.

FIG. 4 is a flowchart illustrating certain aspects of another method performed by aspects of the communication environment shown in FIG. 1 and/or the user ratings mechanism shown in FIG. 2.

FIG. 5 is a flowchart illustrating certain aspects of yet another method performed by aspects of the communication environment shown in FIG. 1 and/or the user ratings mechanism shown in FIG. 2.

FIG. 6 is a simplified functional block diagram of an exemplary configuration of an operating environment in which the user ratings mechanism shown in FIG. 2 and/or the methods shown in FIGS. 3, 4, and 5 may be implemented or used.

### DETAILED DESCRIPTION

Systems and methods are disclosed below for using user ratings and a user ratings mechanism (“URM”) for establishing user ratings to affect operations of content management devices (which may operate content libraries) and content playback devices such as portable media players. The user rating is generally in a binary form that reflects a personal emotional context, where a user can choose between two options to rate a content item, or can choose to leave the content item unrated. An exemplary rating system may be employed during all phases of content consumption, including discovery, management, and playback.

The following definitions are used in this description.

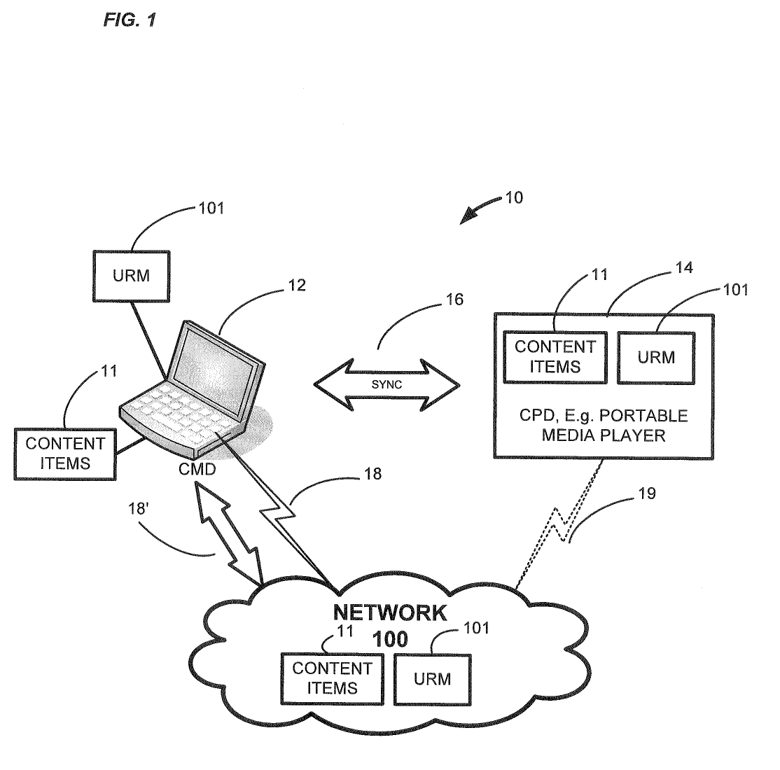

“Content items” (elements 11 of FIG. 1), “items of content”, or just “content” are files corresponding to music, movies, television shows, pictures, video clips, etc. In particular, the terms represent any commercial or non-commercial stored digital content. Examples include but are not limited to digital media content (such as audio files, video files, image files, multimedia files, podcasts, playlists and the like. Content items may exist in any known or later developed format or combination thereof, and may be protected by one or more enforceable intellectual property rights of one or more third parties, such as copyrights, patent rights, trademark rights, or trade secret rights. The ratings described herein may be applied to an individual content item or to a group of content items, such as an album, a grouping of content items by a particular artist, a grouping of shows in a season of a television series, an audio or video podcast series, etc.

A “content playback device” (CPD) (element 14 of FIG. 1) is any device that can play content items. Some ability to manage the content items thereon is usually accorded, such as the ability to delete a content item or to add to or modify a playlist. However, in many cases, such functionality is minimal as users prefer to manage their content on a device where the content items may be more easily visualized, such as a “content management device” (CMD) described below. An exemplary content playback device is a portable music player (PMP).

A “content management device” (element 12 of FIG. 1) is any device whose primary function is to control and manage content items. A CMD may also play back content items. An exemplary CMD is a personal computer (PC). A CMD may also be, e.g., a mobile phone, on which content items may be downloaded and played back or synchronized to another device.

“Synchronization” refers to the act of making identical two sets of content items, one on each of two different devices, whether CMDs or CPDs. In many cases, content is managed on a CMD and the managed content is periodically synchronized with a CPD that the user carries as part of the user's daily routine. In many cases, CMDs can store much more than CPDs, and thus it is a subset of content items on a CMD that is synchronized with a CPD (and thus it is the subset that is made identical with the items on the CPD, not the entire library of content items). CMDs may also synchronize with CMDs—this may occur, e.g., if a user synchronizes content downloaded from an online service to a mobile phone, and then synchronizes the mobile phone to a PMP. Synchronization may be partial; that is, only a portion of the content on one device may be synchronized to another device. This may occur, e.g., when only certain playlists are synchronized. A synchronization procedure may be employed to transfer and/or update rating information between CPDs, CMDs, and/or online services. The synchronization procedure may be automatic or manual. Synchronization may also occur if a user has a content library stored online and which is accessed by, e.g., a web application. In this case, the synchronization may be directly from the online library to a CPD or CMD. While the term “synchronization” refers to data and information flowing in both directions between a CMD and a CPD, the term often relates to simply downloading items from a CMD to a CPD. In some embodiments, synchronization may simply lead to the CPD having the same content items as the CMD. However, in other embodiments, the synchronization step itself may be affected or altered by the rating system, such as the preferential download of certain content items, etc. The synchronization step may also include a mapping of rating systems. For example, if an online service (see below) employs a five-star rating system, and the CMD/CPD of the current system employs a binary, an appropriate mapping may be made during synchronization to convert the five-star system to the binary system. Of course, such a mapping may be made at any later time as well. The data corresponding to the five-star rating may be maintained, so that the original rating on the five-star scale may be retrieved and employed in a subsequent re-conversion; that is, the data need not be destroyed upon conversion.

The term “preferential” or “preference” and the like relate to a priority given to the download, playback or display of certain content items. In many cases in this description, preference is given to content items for which a user has selected the first choice. Preferential may also be used with regard to second-choice items, which may be preferentially removed, erased, deleted, disposed lower on a playlist, lessened in frequency in a shuffle algorithm, etc., depending on the embodiment.

“Online service” refers to a repository of content items which is connected to a network and which may be used to download content items or store chosen content items. In many cases, the online service is an internet storefront from which is downloaded music, videos, television shows, podcasts, video games, or other digital content items.

As certain embodiments may be employed directly to manage a user library, such as on a user PC, CMD, CPD, network, or other device or combination of devices, it is noted that a “user library” or “user content library” is employed with respect to such embodiments. In this case, the systems and methods discussed herein may be used to directly affect and manipulate the content on a user system.

A “rating” refers to a subjective judgment a user bestows on a content item. In most embodiments of this system and method, a “binary rating system” is employed, in which either “first choice” or “second choice” is associated with a content item, and a user's rating choice reflects a personal emotional context that is virtually universally understood. That is, a rating may be one of two choices, or may also remain in an unrated state. Exemplary ratings may be +/−1, up or down arrows, “heart” or “broken heart” symbols, yes/no, positive/negative, ILI/IDLI, “thumbs up” or “thumbs down”, etc.

A “playlist” is a collection of media files to be played back in a given order as determined by the user. A “random” playlist or “shuffle” is one in which an entire user library, or a subset of the same, is played back in a random order. The randomness may vary, and systems and methods discussed herein may cause certain items to be played back sooner or more often in a shuffle.

To “affect an operation” means to have a direct or indirectimpact how the operation is carried out. It may be the sole factor or other factors may also be employed. If a discovery operation is affected, an embodiment of the systems or methods described herein is used to affect, e.g., recommendations an online store makes to a user. If a management operation is affected, an embodiment of the systems or methods described herein is used to affect, e.g., what content items are synchronized or downloaded to a portable media player. If a playback operation is affected, an embodiment of the systems or methods described herein is used to affect, e.g., what content items are played back.

The systems and methods may be embodied in a number of ways, examples of which follow. The examples are divided into those pertaining to playback, management, and discovery, all of which are regarded as various phases of consumption. Without intending to be limiting, broadly-speaking, “discovery” relates to interaction with an external library of content items, such as an online service or a peer device. “Management” relates to how content is organized and manipulated on a CMD or CPD. “Playback” relates to how content items are played or otherwise used on a CMD or CPD. Significant overlap may exist between the consumption types. Features are described below as they may be conveniently categorized, but such categorization should not be construed as limiting features or functionality in any way. In addition, while most manipulation of ratings and other functionality may be most easily performed on a CMD, the same, to a greater or lesser extent, may also be performed on the CPD. A button or other input device may be situated on the CPD or CMD which allow a convenient enablement or disablement of the ratings system and method. Once enabled, the systems and methods may be employed as described. If disabled, the system may return to the way it operated without ratings.

Turning to the drawings, where like numerals designate like components, FIG. 1 shows one basic system 10 in which the user ratings mechanism (“URM”) 101 and techniques described herein may be employed or used. A CMD 12, such as a PC, which may store content items 11, communicates with a network 100, such as the internet. The communication may be via a wireless link 18, a wired link 18′, or both.

Collectively, network 100 represents any existing or future, public or private, wired or wireless, wide-area or local-area, packet-switched or circuit-switched, one-way or two-way digital data transmission infrastructures or technologies. As shown, content items 11 may also be stored at various locations within network 100. Exemplary networks 100 include: the Internet; managed WANs (for example, cellular networks, satellite networks, fiber-optic networks, co-axial cable networks, hybrid networks, copper wire networks, and over-the-air broadcasting networks such as television, radio, and datacasting networks); and local area networks (for example, wireless local area networks and personal area networks).

A CPD 14, which may store content items 11, is also shown in FIG. 1, and CPD 14 may optionally communicate with the network 100 via a wireless link 19. It will be clear that wired links may also be employed. The CMD 12 may communicate with the CPD 14 via wired or wireless links, shown collectively by link 16, and the same is often accomplished by way of a synchronization procedure.

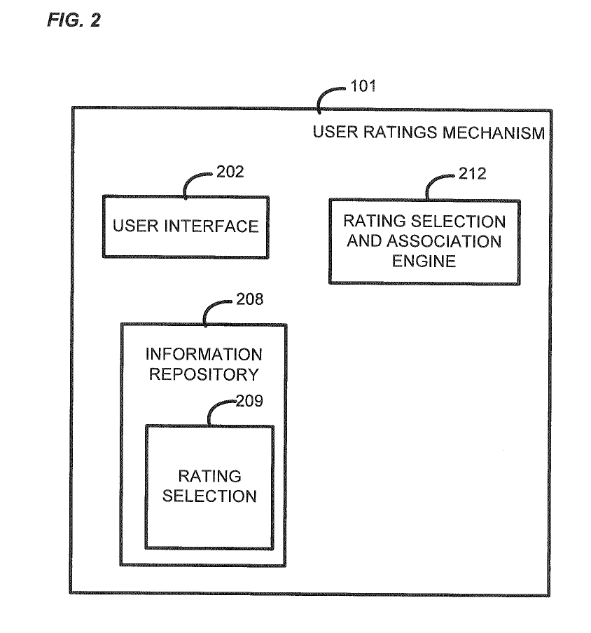

With continuing reference to FIG. 1, FIG. 2 is a simplified functional block diagram of an exemplary implementation of URM 101. URM 101 includes a user interface 202; an information repository 208, which stores, among other things, user rating selections 209; and a rating selection and association engine (“RSAE”) 212. In general, design choices dictate how specific functions of URM 101 are implemented. Such functions may be implemented using hardware, software, firmware, or combinations thereof.

User interface 202 represents the combination of presentation tools and controls that define the way a user interacts with a particular application or device, such as CMD 12, CPD 14, or a networked server or service within network 100. Presentation tools are used to provide output to a user. An example of a physical presentation tool is a display such as a monitor device. An example of a logical presentation tool is a data organization technique (for example, a window, a menu, or a layout thereof). Controls facilitate the receipt of input from a user. An example of a physical control is an input device such as a remote control, a display, a mouse, a pen, a stylus, a trackball, a keyboard, a microphone, or a scanning device. An example of a logical control is a data organization technique (for example, a window, a menu, or a layout thereof) via which a user may issue commands. It will be appreciated that the same physical device or logical construct may function to provide outputs to, and receive inputs from, a user.

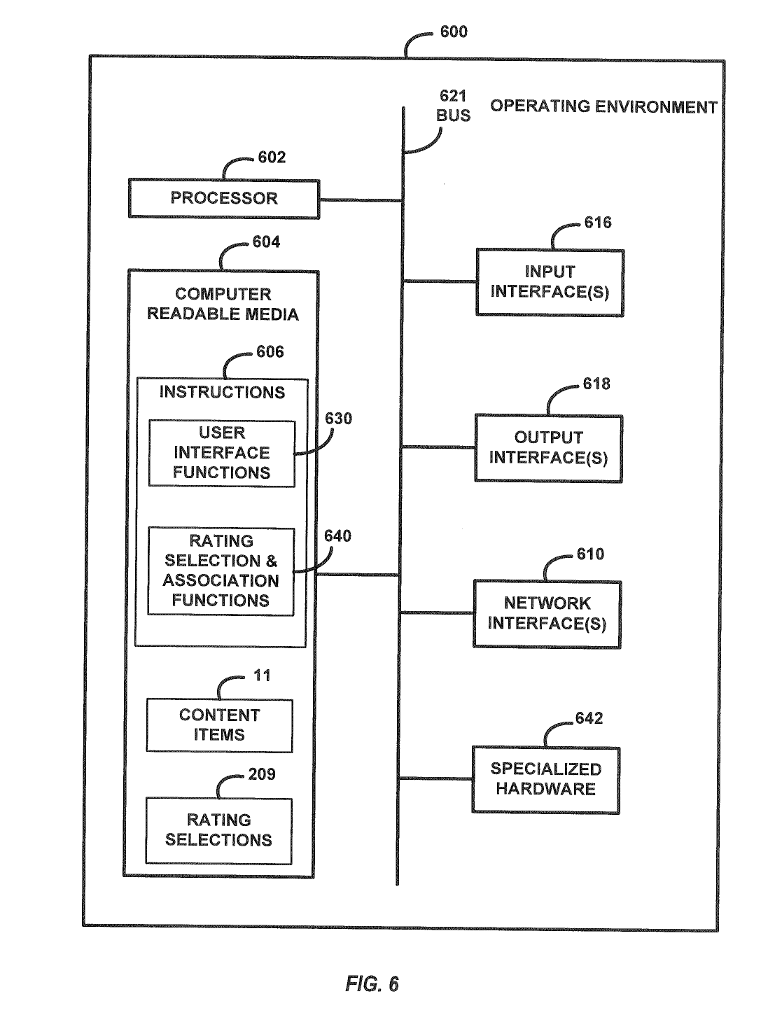

Information repository 208 represents data storage or organization capability for information relating to user rating selections 209 for content items 11. Information repository may be implemented using various types and arrangements of computer-readable media (exemplary computer-readable media 604 are shown and described in connection with FIG. 6).

Rating selections 209 are user-selected rating choices associated with particular content items 11. Generally, a particular content item 11 is associated (for example, tagged using a tag such as an ID3 tag) with a user-selected rating selection 209 having a personal emotional context corresponding to an emotion that the content item 11 invokes in a particular user. Exemplary emotions include but are not limited to: like, corresponding to a rating selection of “I Like It”; dislike, corresponding to a rating selection of “I Don't Like It”; love, corresponding to a rating selection of “I Love It”; hate, corresponding to a rating selection of “I Hate It”, and neutral. The association of the content item 11 and the rating selection 209 serves as a medium for exchange of subjective, yet virtually universally-understandable, information about content item 11.

RSAE 212 is configured to implemented functions of URM 101 relating to arranging for user selection of a rating selection 209, and associating the rating selection with a particular content item 11. In one possible implementation, RSAE 212 implements one or more features of a wide-area or local-area network service. In another possible implementation, RSAE 212 implements one or more features of a client-based application.

Generally, RSAE 212 is responsible for receiving user-selected rating selections 209, and for tagging content items 111 with selected rating selections 209. Tagging may be accomplished using ID3 tags or WMA tags, for example. In one scenario, RSAE 212 maps ratings selections 209 in accordance with a predetermined value scale. One possible value scale is a 0 through 10 value scale, with a ratings assignment as follows: 0=unrated; 4=1 Don't Like It; and 8=I Like It. Additional ratings assignments are also possible, such as 2=I Hate It; 6=neutral; and 10=I Love It. Ranges of value scales may be defined to facilitate mapping between ratings selections 209 and other ratings conventions. For example, values between 1 and 5 may be used to define a “dislike” emotional context, and values between 6 and 10 may be used to define a “like” emotional context.

With continuing reference to FIGS. 1 and 2, FIG. 3 is a flowchart illustrating certain aspects of a method performed by aspects of URM 101. An initial step in a user interaction with content items 11 such as media content is media discovery, which relates to finding media, purchasing the same, and downloading the media either onto a CMD, CPD, or both, e.g., via a synchronization or other such procedure. In this process 20, a network is accessed (step 22). Items of content may be located (step 24). For example, the user may search for certain items and a display of available items meeting the search criteria may be displayed. The user can then rate the content (step 26) by choosing a rating selection 209 that corresponds to an emotion that the content item 11 invokes in the user. For example, the user may strongly like the content item (corresponding to an “I like it” (“ILI”) rating selection, for example, or may strongly dislike the content item (corresponding to an “I don't like it” (“IDLI”) rating selection, for example. Thus, the rating selection will reflect the user's emotion in an intuitively understandable way. In one possible implementation, a pop-up window may appear adjacent found items that allow the user to select a first choice or a second choice, or to leave the item unrated. The window may toggle between the options as well. The ratings may then be employed to affect an operation as will be described (step 28).

One type of operation that may be affected concerns the recommendation of related content items (step 32). That is, if a user indicates that a given content item is ILI, the online service or other network service may recommend items that are related to the ILI item. For example, such other items may be related on the basis of metadata such as ID3 tags. Conversely, if a user indicates that a given content item is IDLI, the online service or other network service may cease, hide, remove, or prohibit recommendations of items that are so marked, or related items.

Another type of operation is that items marked ILI may enjoy preferential treatment or preferential promotion adjacent the user's shopping cart or wish list (step 34). For example, if a user has marked items ILI, upon displaying their shopping cart, a window may open prompting the user if they wish to include the ILI items in their shopping cart. Such information may also be used to direct promotions, emails, or other marketing efforts towards the user, advising them of promotions of the ILI item or of items related to the ILI item by virtue of metadata, etc. In a related embodiment, the advising may occur so long as the related items have not been marked IDLI.

Another type of operation is that rated items, upon acquisition, either by purchase or other means, may have their ratings automatically transferred upon download to the CMD, and such ratings may be further transferred to a CPD upon download or synchronization (step 36).

Another type of operation relates to the use of the system and method in combination with social networking services. In some social networking services, an automatically-generated list of music that the user has currently-played may be displayed. Embodiments of the ratings technique may be employed to eliminate content items marked as IDLI (step 38). In related embodiments, items marked as ILI may enjoy preferential placement or may be called out in other ways.

The above description of systems and methods embodying the ratings technique relating to discovery of media items is in particular regard to content items displayed on a network and rated by a user. It should be noted that in alternative embodiments, and depending upon user acquiescence, prior user history and current user content information may be extracted from the user library and used to perform the same functions above.

An online service may also act in some ways as a social networking service. User ratings may be stored at the online service and used to recommend items or used in any other way as noted above or similar to the above. If a user accumulates “friends” as defined by the online service, they may access all or a portion of the ratings, or may be privy to summaries of the ratings, as desired by the user and as provided for by the social networking service. Such information may be accessed and transmitted to other online services or social networking services, and the rating information may be mapped to the other services' systems as described above. If the rating information is made part of the content item media file, such as in metadata, e.g., ID3 tags, then the rating information may be directly accessible by any other system.

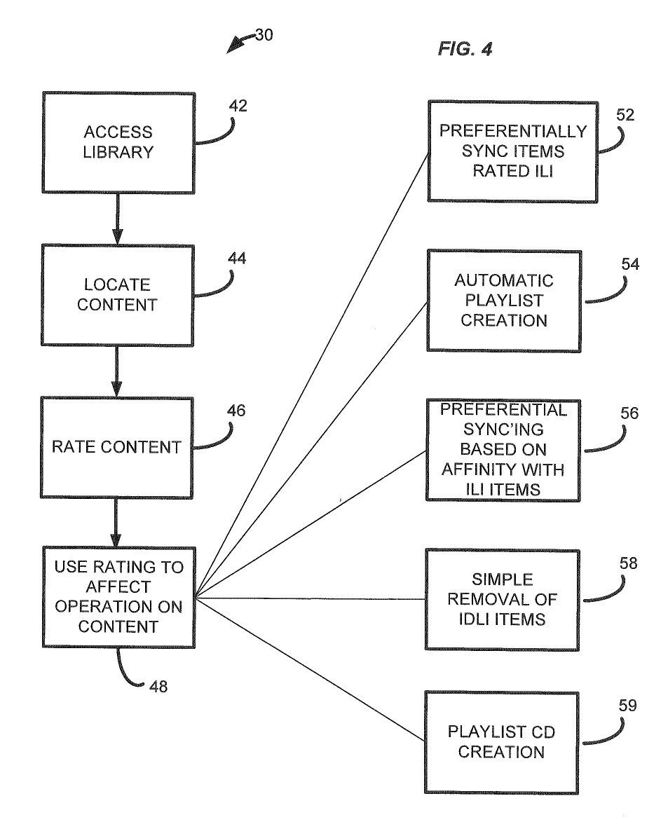

Another step in a user interaction with media is media management (FIG. 4), which relates to organizing content items on a CMD or CPD or both. Management may also relate to synchronization or downloading procedures between a CMD and a CPD. In this process 30, a user library is accessed (step 42). The user library may typically be stored on a CMD such as a user computer but may also include online storage or storage on a CPD. Items of content may be located (step 44). For example, the user may search for certain items and a display of available items meeting the search criteria may be displayed, e.g., the user may search for all albums or songs by a given artist. The user can then rate the content (step 46). For example, the user library may have a spreadsheet view of all the pertaining content items. A pop-up window may appear adjacent found items that allow the user to select a first choice or a second choice, or to leave the item unrated. The window may toggle between the options as well. The ratings may then be employed to affect an operation as will be described below (step 48).

One type of operation that may be affected concerns synchronization procedures (step 52). That is, if a user indicates that a given content item is ILI, that item may be preferentially synchronized or downloaded to the CPD. Conversely, if a user indicates that a given content item is IDLI, that item may be skipped or preferentially not synchronized or downloaded to the CPD. Such functionality may be particularly useful where the storage capacity of the CPD is limited and is less than that necessary to download or synchronize all desired items.

Another type of operation is that items marked ILI may automatically be copied to a dynamic ILI playlist (step 54). That is, all items so marked may be included on a playlist according to, e.g., the time stamp when they were rated. As noted above, such a list could also be created on the CPD based on user input, and such ratings could be transferred to the CMD during a synchronization procedure.

A further type of operation that may be affected also concerns synchronization procedures (step 56). That is, if a user indicates that a given content item is ILI, not only that item (as in step 52) but also related items may be preferentially synchronized or downloaded to the CPD. Conversely, if a user indicates that a given content item is IDLI, items related to that item may be skipped or preferentially not synchronized or downloaded to the CPD. Such functionality may be useful for the storage reasons as noted above. It is noted in this context that “related” items may include those that are related by virtue of metadata, e.g., ID3 tags.

A further type of operation that may be affected is automatic removal (step 58). That is, if a user indicates that a given content item is IDLI, the content item may be automatically removed or deleted or hidden. In a related embodiment, items related to the content item may also be automatically removed or deleted or hidden. In a further related embodiment, items related to the IDLI item are presented to the user, who is then prompted prior to their removal. This embodiment may also be employed where a user receives a file from another user, either on their CMD or CPD: if the user lacks sufficient storage capacity to store the content item, IDLI items may be removed, with an optional prompting of the user prior to removal.

A further type of operation that may be affected concerns CD burning of a playlist (step 59). If a user desires to burn a CD of a playlist where the playlist includes items of different ratings, ILI items may be preferentially burned. For example, ILI items may be burned followed by UR items.

The above description of systems and methods embodying the ratings technique relating to management of media items is in particular regard to content items displayed as part of a user library. As noted with regard to content discovery, in alternative embodiments where the library is stored online, and depending upon user acquiescence, prior user history and current user content information may be extracted from the user library and used to perform the functionality above.

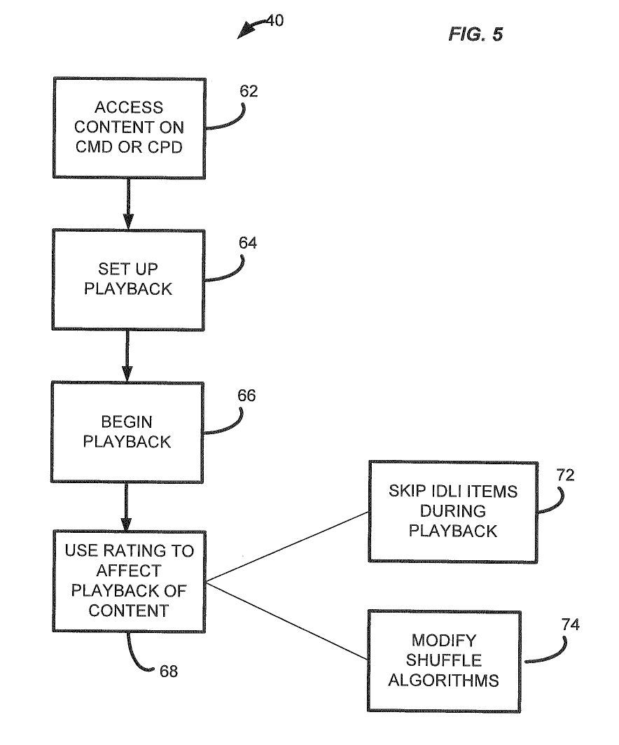

Another step in a user interaction with media is media playback (FIG. 5), which may occur on either a CMD or CPD or both. Playback methods 40 generally relate to viewing, listening, or otherwise playing back the content item in whatever manner is appropriate. For example, playback of a music content item is often playing a song. Playback of a movie content item may be watching the movie in a suitable viewer.

Playback starts by accessing a content item or a set of content items, such as on a playlist, on a CMD or CPD (step 62). In some embodiments, a playback scheme may then be setup (step 64), though in many embodiments the setup may be minor or may be entirely skipped. The playback may then be initiated (step 66). The playback operation may be affected using the ratings stored via user input (step 68).

One type of operation that may be affected concerns playback of a playlist. That is, during playback, e.g., of a playlist, a shuffle, a grouping of items such as by album or artist, etc., if a content item is queued for playback but is rated IDLI, that item may be either removed from the queue or may be skipped over (step 72). Conversely, items that are rated ILI may be preferentially, using any sort of promotion or sorting algorithm, moved to the beginning of the queue.

Another type of playback operation concerns shuffle algorithms. That is, during playback of a shuffle, the system and method may preferentially situate content items rated ILI so that the same play more often, or closer to the beginning, or both, within a shuffle playback (step 74). As in several other operations, the converse may also be true: items rated IDLI may be skipped, may play less frequently, and/or may play nearer to the end of a shuffle.

Thus, it can be seen that the systems and methods described enable a convenient way to intuitively affect the operation of a content library and/or a portable media device. In this connection, it is noted that various devices can synchronize, search/browse, remotely control other devices, and share data items whether or not the data items are present on a particular device. The use of filters such as data selection criteria, device characteristics, and network characteristics can be used to create algorithms for “intelligent” device/data item selection and data access. In addition technologies adapted for synchronization topologies guarantee that data on each endpoint is correct updated as changes are made and conflicts resolved as necessary. Although not specifically described herein, the use of DRM and identity management techniques URM described herein would accommodate a wide variety of business models that simultaneously support the often diverse interests of individuals and intellectual property rights holders.

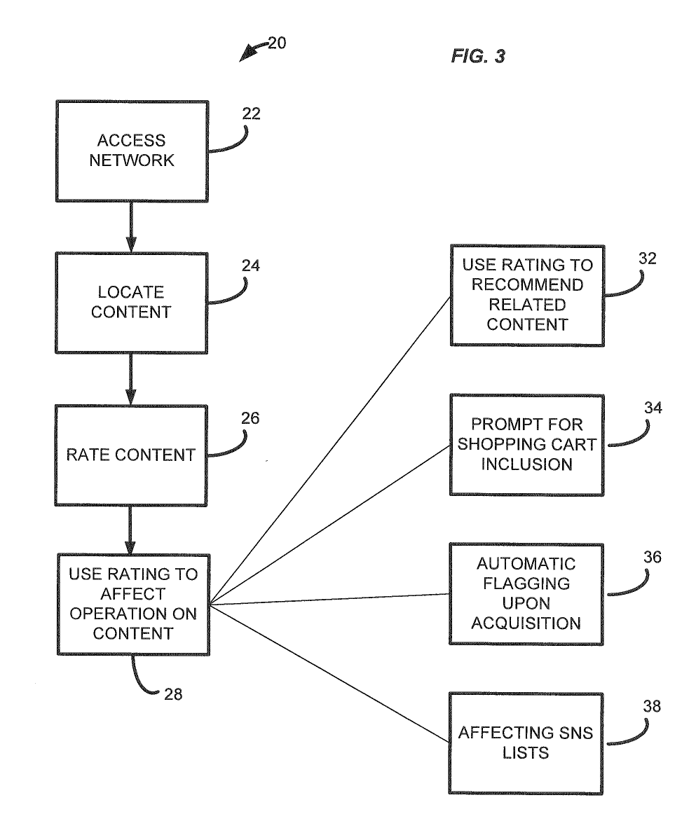

FIG. 6 is a block diagram of an exemplary configuration of an operating environment 600 (such as a client-side device or application or a networked server or service) in which all or part of URM 101 and/or the methods shown and discussed in connection with FIGS. 3-5 may be implemented or used. Operating environment 600 is generally indicative of a wide variety of general-purpose or special-purpose computing environments, and is not intended to suggest any limitation as to the scope of use or functionality of the systems and methods described herein.

As shown, operating environment 600 includes processor 602, computer-readable media 604, and computer-executable instructions 606. One or more internal buses 621 may be used to carry data, addresses, control signals, and other information within, to, or from operating environment 600 or elements thereof.

Processor 602, which may be a real or a virtual processor, controls functions of the operating environment by executing computer-executable instructions 606. The processor may execute instructions at the assembly, compiled, or machine-level to perform a particular process.

Computer-readable media 604 may represent any number and combination of local or remote devices, in any form, now known or later developed, capable of recording, storing, or transmitting computer-readable data, such as the above-noted computer-executable instructions 606 (user interface functions 630 and rating selection and association functions 640 are shown), content items 11, or rating selections 209. In particular, the computer-readable media 604 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. The computer-readable media may also include transmission media and data associated therewith. Examples of transmission media/data include, but are not limited to, data embodied in any form of wireline or wireless transmission, such as packetized or non-packetized data carried by a modulated carrier signal.

Computer-executable instructions 606 represent any signal processing methods or stored instructions. Generally, computer-executable instructions 606 are implemented as software components according to well-known practices for component-based software development, and encoded in computer-readable media. Computer programs may be combined or distributed in various ways. Computer-executable instructions 606, however, are not limited to implementation by any specific embodiments of computer programs, and in other instances may be implemented by, or executed in, hardware, software, firmware, or any combination thereof.

Input interface(s) 616 are any now known or later developed physical or logical elements that facilitate receipt of input to operating environment 600.

Output interface(s) 618 are any now known or later developed physical or logical elements that facilitate provisioning of output from operating environment 600.

Network interface(s) 610 represent one or more physical or logical elements, such as connectivity devices or computer-executable instructions, which enable communication between operating environment 600 and external devices or services, via one or more protocols or techniques. Such communication may be, but is not necessarily, client-server type communication or peer-to-peer communication. Information received at a given network interface may traverse one or more layers of a communication protocol stack.

Specialized hardware 642 represents any hardware or firmware that implements functions of operating environment 600. Examples of specialized hardware include encoder/decoders decrypters, application-specific integrated circuits, clocks, and the like.

The methods shown and described in connection with FIGS. 3-5 may be implemented in one or more general, multi-purpose, or single-purpose processors. Unless specifically stated, the methods described herein are not constrained to a particular order or sequence. In addition, some of the described methods or elements thereof can occur or be performed concurrently.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

The rating techniques and systems have been described with respect to a number of embodiments. It will be recognized that variations may be made that still fall within the scope of the appended claims. For example, while the ILI, IDLI, and UR notations have been described above, the above connote value judgments with respect to content items, although implementations that incorporate other value judgments are also possible. Any binary system may be employed, including those that do not incorporate a UR choice. The system need not be binary—any number of states may be provided for, so long as the same are convenient to use by consumers. The primary data type disclosed in this description pertains to the rating system; however the system and method may deduce (or directly obtain data about) user ratings of items via analysis of playback frequency, statistics on accumulation of a particular artist's or genre's content items, etc. Where contrary ratings have been provided by the consumer, a rule may be provided to determine which rating prevails in a synchronization procedure. For example, the last-in-time rating (most recent timestamp) may prevail.

As it is understood that embodiments other than the specific embodiments described above may be devised without departing from the spirit and scope of the appended claims, it is intended that the scope of the subject matter herein will be governed by the following claims.

1. A method of discovering, managing, organizing, or playing back content items in a library of content items, comprising:
arranging for user selection of a rating choice via a user interface, the rating choice identifying an emotional context representing a user opinion of a content item;
associating the selected rating choice with the content item, the association serving as a medium for exchange of information about the content item; and
performing an operation on at least a subset of a library of content items based on the rating choice.

2. The method of claim 1, wherein the step of associating comprises tagging the content item with metadata reflecting the selected rating choice.

3. The method of claim 1, wherein the rating choice comprises a binary rating choice, and wherein a user can select either one of two choices corresponding to the binary rating choice, a first choice or a second choice, or can leave the binary rating choice corresponding to the content item unselected, wherein the content item is rendered unrated.

4. The method of claim 3, wherein the user interface is associated with an online store, and wherein the performing an operation includes displaying a list of content items for which the user has selected the first choice.

5. The method of claim 2, wherein the user interface is associated with an online store, and wherein after a user selects a rating and acquires an item, the item is downloaded and the rating is transferred to a content management device or a content playback device.

6. The method of claim 2, wherein the user interface is associated with a social networking service, and wherein the performing an operation includes, in an automatically-generated list of content items, listing content items that have ratings corresponding to the first choice and not listing content items that have ratings corresponding to the second choice.

7. The method of claim 2, wherein the user interface is associated with an online service or a user library, and where the performing an operation includes organizing content items according to their binary rating choice.

8. The method of claim 7, wherein the organizing content items includes disposing all content items for which the user has selected the first choice into a playlist.

9. The method of claim 7, wherein the organizing content items includes downloading content items from a content management device to a content playback device, and wherein if the content playback device lacks sufficient memory to store all content items to be downloaded, then preferentially downloading the content items in which the user has selected the first choice.

10. The method of claim 7, wherein the organizing content items includes downloading content items from a content management device to a content playback device, and wherein if the content playback device lacks sufficient memory to store all content items to be downloaded, then deleting content items from the content playback device, one at a time, until sufficient memory has been freed to download all content items for which the user has selected the first choice.

11. The method of claim 7, wherein the organizing content items includes increasing the likelihood that content items, for which the user has selected the first choice, are played during a shuffle or random playlist, and decreasing the likelihood that content items, for which the user has selected the second choice, are played during a shuffle or random playlist.

12. The method of claim 7, wherein the organizing content items includes downloading content items from a content management device to a content playback device, and wherein if the content playback device lacks sufficient memory to store all content items to be downloaded, then preferentially downloading content items related to content items in which the user has selected the first choice.

13. The method of claim 2, wherein the user interface is associated with a user library on a content management device or with a content playback device, and wherein playback of a random playlist on the content management device or on the content playback device includes increasing the likelihood that content items, for which the user has selected the first choice, are played during the shuffle or random playlist, and decreasing the likelihood that content items, for which the user has selected the second choice, are played during the shuffle or random playlist.

14. The method of claim 1, wherein the library of content items comprises an online service where users may access content items selected from the group comprising: music; movies; videos; games; and podcasts.

15. The method of claim 1, wherein the library of content items comprises a user's content library stored on a device selected from the group comprising: a personal computer; a portable media player; a content playback device; a content management device; and a network.

16. A computer-readable storage medium encoded with computer-executable instructions which, when executed by a processor, perform a method comprising:
presenting a user interface to a user;
receiving user-input information via the user interface, the user-input information identifying a user opinion having a binary emotional context;
evaluating a relationship between the user-input information and user ratings associated with a plurality of content items in a library of content items; and
based on the evaluation, arranging for identification of a subset of content items in the library of content items.

17. The computer-readable medium storage medium according to claim 16, wherein the computer-executable instructions are executable by a client-side processor.

18. The computer-readable storage medium according to claim 16, wherein the computer-executable instructions are executable by a network-side processor.

19. An apparatus, comprising:
a user interface configured to receive a user opinion having a binary emotional context;
a computer-readable storage medium; and
a processor responsive to the computer-readable storage medium, to the user interface, and to computer-executable instructions stored on the computer-readable medium, the computer-executable instructions executable by the processor to
store data corresponding to the user opinion, and
based on the stored data, perform an operation on at least a subset of a library of content items, the operation selected from the group comprising: discovery; management; and playback of the subset of content items.

20. The apparatus according to claim 19, wherein the apparatus is selected from the group comprising: a client-side device; and a network-side device.
